(19) United States
(12) Patent Application Publication
(10) Pub. No.: US 2025/0097361 A1
(43) Pub. Date: Mar. 20, 2025

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Akihide OSHIMA, Kanagawa (JP)

(73) Assignee: FUJIFILM Business Innovation Corp., Tokyo (JP)

(21) Appl. No.: 18/439,480

(22) Filed: Feb. 12, 2024

(30) Foreign Application Priority Data
Sep. 20, 2023 (JP) 2023-153899

(51) Int. Cl. H04N 1/00

(52) U.S. Cl. CPC H04N 1/00933

(57) ABSTRACT

An information processing system includes a processor configured to: in a case where a periodic synchronization process of periodically synchronizing data stored in an external device with data in the information processing system overlaps an immediate synchronization process of immediately synchronizing the data stored in the external device with the data in the information processing system in accordance with an instruction from a user, preferentially execute the synchronization process that has been generated earlier.

### CROSS-REFERENCE TO RELATED APPLICATIONS

This application is based on and claims priority under 35 USC 119 from Japanese Patent Application No. 2023-153899 filed Sep. 20, 2023.

### BACKGROUND

### (i) Technical Field

The present disclosure relates to an information processing system, a non-transitory computer readable medium storing a program, and an information processing method.

### (ii) Related Art

JP5003168B discloses a management device that periodically communicates with an information processing apparatus with a polling signal and immediately receives failure information from the information processing apparatus in a case where a failure has occurred in the information processing apparatus.

### SUMMARY

There is known an information processing system that executes a synchronization process of synchronizing data stored in an external device with data of an own system to reflect information of the settings of the information processing system, the usage status of the information processing system, and the like to data that is transmitted from the information processing system to the external device and then is stored in the external device, or to reflect setting contents of data stored in the external device to the information processing system.

The synchronization process includes a periodic synchronization process in which the synchronization process is periodically executed and an immediate synchronization process in which the synchronization process is immediately executed based on an instruction from a user. However, in a case where the periodic synchronization process overlaps the immediate synchronization process and the two processes are simultaneously executed, a problem may occur.

Aspects of non-limiting embodiments of the present disclosure relate to an information processing system, a non-transitory computer readable medium storing a program, and an information processing method that are capable of, in a case where a periodic synchronization process overlaps an immediate synchronization process, normally completing execution of the synchronization process that has been generated earlier.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: in a case where a periodic synchronization process of periodically synchronizing data stored in an external device with data in the information processing system overlaps an immediate synchronization process of immediately synchronizing the data stored in the external device with the data in the information processing system in accordance with an instruction from a user, preferentially execute the synchronization process that has been generated earlier.

### BRIEF DESCRIPTION OF THE DRAWINGS

Exemplary embodiment(s) of the present invention will be described in detail based on the following figures, wherein:

FIG. 1 is a diagram showing a configuration of a digital shadow system according to an exemplary embodiment of the present disclosure;

FIG. 2 is a diagram for describing a synchronization process executed between a cloud server and an image forming apparatus;

FIG. 3 is a block diagram showing a hardware configuration of the image forming apparatus in the exemplary embodiment;

FIG. 4 is a block diagram showing a functional configuration of the image forming apparatus in the exemplary embodiment;

FIG. 5 is a sequence diagram showing a processing flow in a case where a periodic synchronization process and an immediate synchronization process overlap each other between the image forming apparatus and the cloud server;

FIG. 6 is a sequence diagram showing a processing flow in a case where the periodic synchronization process and the immediate synchronization process overlap each other between the image forming apparatus and the cloud server; and

FIG. 7 is a sequence diagram showing a processing flow in a case where the periodic synchronization process and the immediate synchronization process overlap each other between the image forming apparatus and the cloud server.

### DETAILED DESCRIPTION

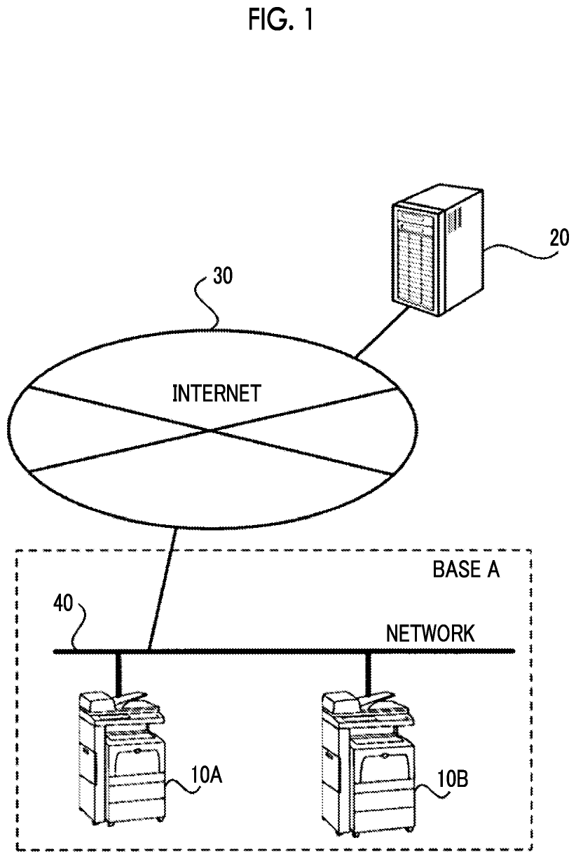

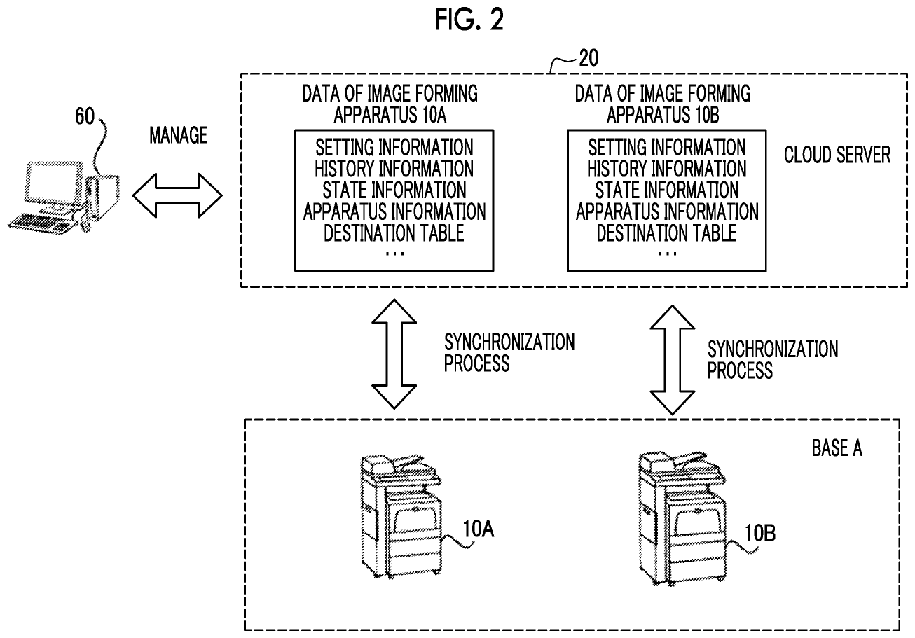

Hereinafter, an exemplary embodiment of the present disclosure will be described in detail with reference to the drawings. FIG. 1 is a diagram showing a configuration of a digital shadow system according to the exemplary embodiment of the present disclosure. FIG. 2 is a diagram for describing a synchronization process executed between a cloud server 20, and image forming apparatuses 10A and 10B.

As shown in FIG. 1, the digital shadow system in the exemplary embodiment of the present disclosure has a configuration in which two image forming apparatuses 10A and 10B installed in a base A and the cloud server 20 are connected to each other via the Internet 30. The image forming apparatuses 10A and 10B are mutually connected by a network 40 in the base A. The image forming apparatuses 10A and 10B are so-called multifunction devices having a plurality of functions such as a printing function, a scanning function, a copying function, and a facsimile function. The image forming apparatuses 10A and 10B are examples of an information processing system in the technique of the present disclosure. The cloud server 20 is an example of an external device in the technique of the present disclosure.

As shown in FIG. 2, the cloud server 20 provides a service called digital shadow in which various types of data such as setting information, history information, state information, apparatus information, and a destination table, which are stored in a physical device connected by the Internet 30 are stored in synchronization with the physical device.

Specifically, the cloud server 20 stores various types of data such as the setting information, the history information, the state information, the apparatus information, and the destination table of the image forming apparatuses 10A and 10B that are physical devices while executing the synchronization process with the image forming apparatuses 10A and 10B.

Here, the setting information is information related to the setting necessary for the operations of the image forming apparatus 10A and 10B.

The history information is information related to the history of jobs such as printing, scanning, copying, and facsimile, which are executed by the image forming apparatus 10A and 10B. Examples of the history information include information related to the execution time of a job, the number of times of executing the job, and the billing amount when the job is executed, and the like.

The state information is information related to a state that changes with the lapse of time in the image forming apparatus 10A and 10B. Examples of the state information include information related to the remaining amount of consumables such as a toner and paper in the image forming apparatus 10A and 10B, an operation status (during a normal operation or during the stop due to an occurrence of an abnormality) of the image forming apparatus 10A and 10B, and the like.

The apparatus information is information related to the device configuration of the image forming apparatuses 10A and 10B, that is, the functions mounted on the image forming apparatuses 10A and 10B.

The destination table is information such as a name, a facsimile number, and an e-mail address, which is managed for each destination.

With such a service, even in a case where it is not possible that a terminal device that manages a certain device is directly connected to a management target device, the terminal device can check the state of the management target device and perform the management such as setting change. For example, a case where an external terminal device 60 attempts to change the setting information of the image forming apparatus 10A will be described. First, the external terminal device 60 changes the setting information of the image forming apparatus 10A in the cloud server 20. Then, in a case where the image forming apparatus 10A executes the synchronization process with the cloud server 20, the image forming apparatus 10A acquires the updated setting information and changes the setting information of the image forming apparatus 10A.

That is, by using such a service, even in a case where connection of the external terminal device 60 to the image forming apparatuses 10A and 10B set in the base A is not possible, the external terminal device 60 can check the states of the image forming apparatuses 10A and 10B, update the setting information, and the like.

Next, the image forming apparatus 10A in the digital shadow system of the present exemplary embodiment will be described in detail. In the following description, the description will be made focusing on the operation of the image forming apparatus 10A, and the image forming apparatus 10B and the like also have the similar configuration.

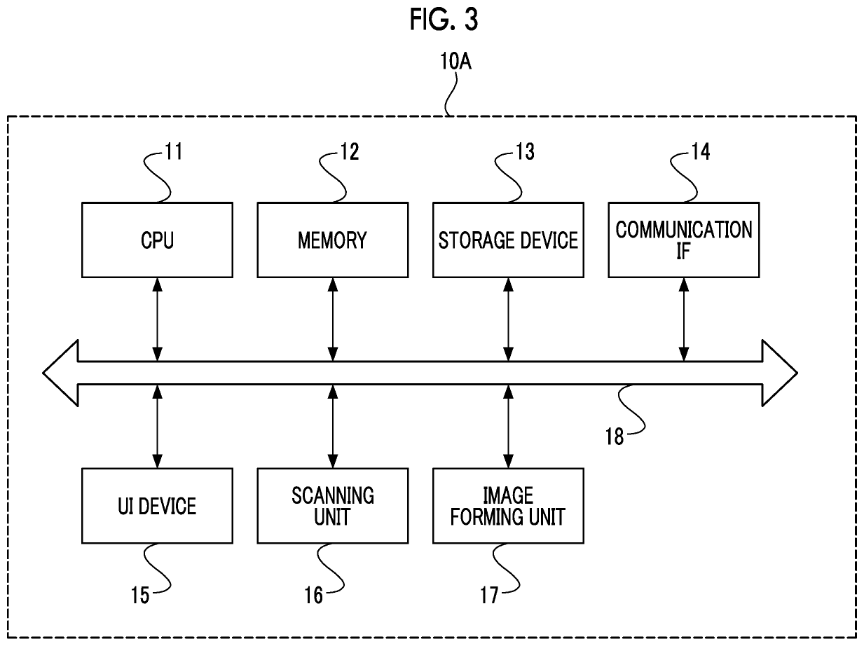

FIG. 3 is a block diagram showing a hardware configuration of the image forming apparatus 10A in the present exemplary embodiment. As shown in FIG. 3, the image forming apparatus 10A includes a central processing unit (CPU) 11, a memory 12, a storage device 13 such as a hard disk drive, a communication interface (abbreviated as an IF) 14 for transmitting and receiving data to and from an external device and the like via the network, a user interface (abbreviated as an UI) device 15 including a touch panel, a liquid crystal display, and a keyboard, a scanning unit 16, and an image forming unit 17. These components are connected to each other via a control bus 18.

The CPU 11 is a processor that controls the operation of the image forming apparatus 10A by executing a predetermined process based on a control program stored in the memory 12 or the storage device 13. In the present exemplary embodiment, description will be made on the assumption that the CPU 11 reads and executes the control program stored in the memory 12 or the storage device 13, but the present disclosure is not limited to this. The control program may be provided in a form of being recorded on a computer readable recording medium. For example, the program may be provided in a form of being recorded on an optical disk such as a compact disc (CD)-ROM and a digital versatile disc (DVD)-ROM, or in a form of being recorded on a semiconductor memory such as a universal serial bus (USB) memory and a memory card. Further, the control program may be acquired from the external device via a communication line connected to the communication IF 14.

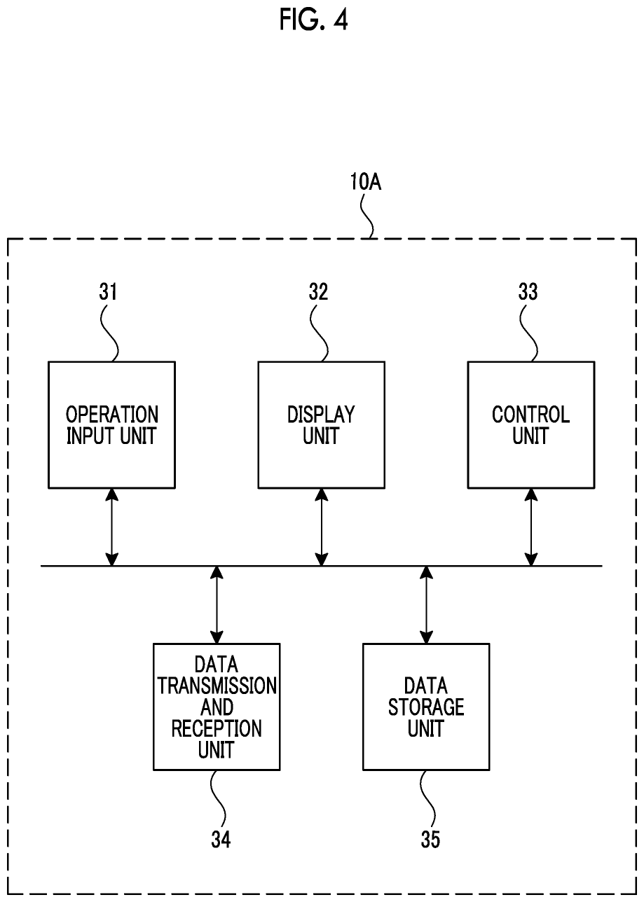

FIG. 4 is a block diagram showing a functional configuration of the image forming apparatus 10A implemented by executing the control program. As shown in FIG. 4, the image forming apparatus 10A in the present exemplary embodiment includes an operation input unit 31, a display unit 32, a control unit 33, a data transmission and reception unit 34, and a data storage unit 35. In the block diagram shown in FIG. 4, functional blocks related to image formation processing and the like are omitted.

The operation input unit 31 inputs information on various operations performed by the user. The display unit 32 is controlled by the control unit 33 and displays various types of information to the user.

The control unit 33 performs control processing for the overall operation of the image forming apparatus 10A. In addition, the control unit 33 stores shared data acquired from the cloud server 20 via the data transmission and reception unit 34 in the data storage unit 35, and, for example, periodically communicates with the cloud server 20, and executes a synchronization process of synchronizing the shared data in the data storage unit 35 with the shared data stored in the cloud server 20.

The data transmission and reception unit 34 transmits and receives data to and from an external device such as the cloud server 20. The data storage unit 35 stores various types of data such as the destination table synchronized with the cloud server 20.

The synchronization process executed in the digital shadow system includes a periodic synchronization process of periodically synchronizing data stored in the cloud server 20 with data in the image forming apparatus 10A, and an immediate synchronization process of immediately synchronizing the data stored in the cloud server 20 with the data in the image forming apparatus 10A in accordance with an instruction from the user. In a case where the periodic synchronization process overlaps the immediate synchronization process, and the two processes are simultaneously executed, a problem may occur.

In order to address such a problem, in a case where the periodic synchronization process overlaps the immediate synchronization process, the control unit 33 in the present exemplary embodiment preferentially executes the synchronization process that has been generated earlier.

The control unit 33 may execute the synchronization process that has been generated later after the completion of the synchronization process that has been generated earlier. In this case, the synchronization process that has been generated later may be continuously executed after the completion of the synchronization process that has been generated earlier, or may be executed with time after the completion of the synchronization process that has been generated earlier.

In a case where the synchronization process that has been generated earlier is the immediate synchronization process and the synchronization process that has been generated later is a whole-periodic synchronization process in which all types of setting information of the image forming apparatus 10A are synchronized with each other, the control unit 33 may complete the immediate synchronization process that has been generated earlier, and then continuously execute the whole-periodic synchronization process.

In a case where the immediate synchronization process is generated during the execution of the periodic synchronization process and a synchronization item of the periodic synchronization process is different from a synchronization item of the immediate synchronization process, the control unit 33 may stop the periodic synchronization process and execute the immediate synchronization process.

Here, the “synchronization item” is an item for each classification of various types of data such as the setting information, the history information, the state information, the apparatus information, and the destination table. That is, in a case where the items are different even in the same classification, it is considered that the synchronization items are different from each other.

In addition, in a case where the synchronization process that has been generated earlier is the periodic synchronization process, the synchronization process that has been generated later is the immediate synchronization process, and there is a synchronization item provided only in the immediate synchronization process, the control unit 33 may cause the periodic synchronization process to include the synchronization item provided only in the immediate synchronization process and execute the periodic synchronization process.

In addition, in a case where the synchronization process that has been generated earlier is the periodic synchronization process, the synchronization process that has been generated later is the immediate synchronization process, setting information included in the synchronization item of the immediate synchronization process is updated on the image forming apparatus 10A side, and the immediate synchronization process is generated before a completion notification of the periodic synchronization process is received from the cloud server 20, the control unit 33 may request the cloud server 20 to execute the immediate synchronization process.

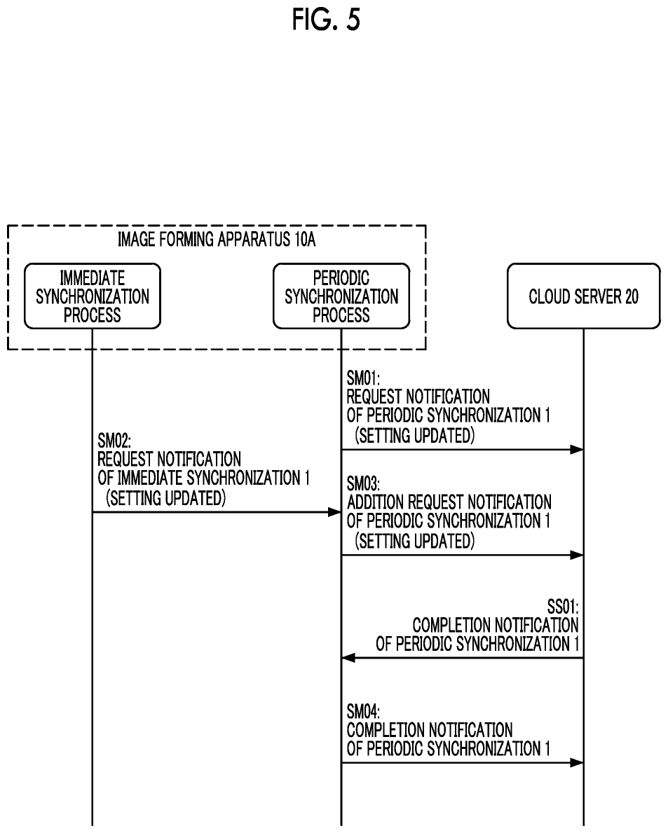

The processing here will be described in detail with reference to FIG. 5. FIG. 5 is a sequence diagram showing a processing flow in a case where the periodic synchronization process and the immediate synchronization process overlap each other between the image forming apparatus 10A and the cloud server 20.

As shown in FIG. 5, in a case where only a process of Periodic synchronization 1 is executed between the image forming apparatus 10A and the cloud server 20, first, the control unit 33 of the image forming apparatus 10A transmits a request notification of Periodic synchronization 1 to the cloud server 20 (Step SM01), and executes the process of Periodic synchronization 1 between the image forming apparatus 10A and the cloud server 20.

In a case where the data synchronization is completed, the cloud server 20 transmits a completion notification of Periodic synchronization 1 to the image forming apparatus 10A (Step SS01).

In a case where the control unit 33 of the image forming apparatus 10A receives the completion notification of Periodic synchronization 1 from the cloud server 20, the control unit 33 transmits the completion notification of Periodic synchronization 1 to the cloud server 20 as a response to the completion notification (Step SM04).

Here, it is assumed that a process of Immediate synchronization 1 is generated during the execution of the process of Periodic synchronization 1 (Step SM02), and setting information included in the synchronization item of the process of Immediate synchronization 1 is updated on the image forming apparatus 10A side.

In a case where the process of Immediate synchronization 1 is generated, and then the control unit 33 of the image forming apparatus 10A receives the completion notification of Periodic synchronization 1 from the cloud server 20, that is, in a case where an occurrence timing of Step SM02 is earlier than Step SS01, the control unit 33 of the image forming apparatus 10A requests the cloud server 20 to execute the process of Immediate synchronization 1.

At this time, the control unit 33 transmits an addition request notification of Periodic synchronization 1 to the cloud server 20 as a request for adding the synchronization content in the process of Immediate synchronization 1 to Periodic synchronization 1 that is currently executed (Step SM03). Then, the control unit 33 executes an addition process of Periodic synchronization 1 between the image forming apparatus 10A and the cloud server 20.

In addition, in a case where the synchronization process that has been generated earlier is the periodic synchronization process, the synchronization process that has been generated later is the immediate synchronization process, setting information included in a synchronization item of the immediate synchronization process is updated on the image forming apparatus 10A side, and the immediate synchronization process is generated after the completion notification of the periodic synchronization process is received from the cloud server 20, the control unit 33 may change a synchronization timing of the synchronization item in accordance with the synchronization item of the immediate synchronization process.

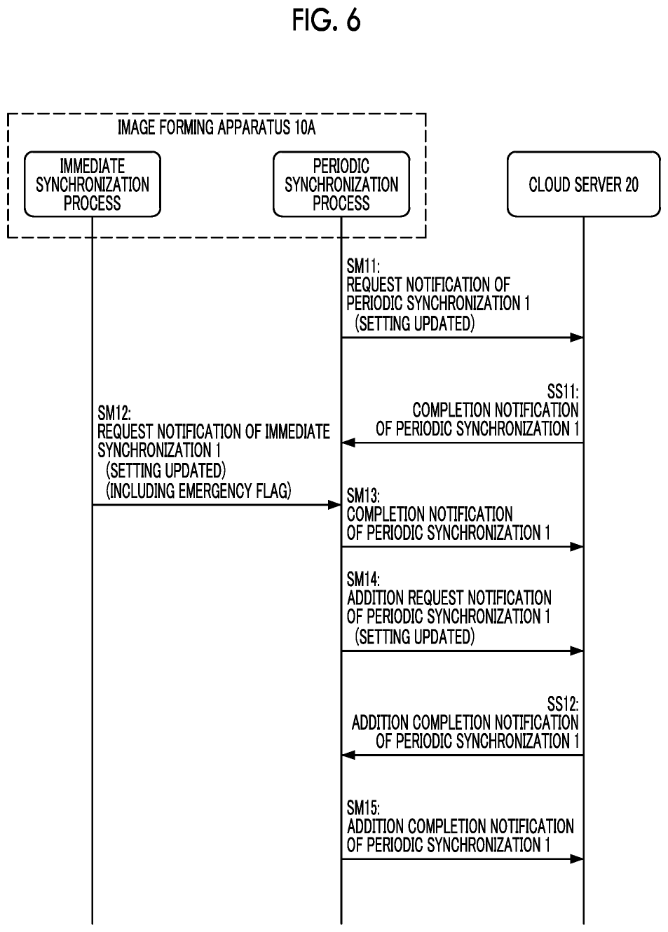

The processing here will be described in detail with reference to FIG. 6. FIG. 6 is a sequence diagram showing a processing flow in a case where the periodic synchronization process and the immediate synchronization process overlap each other between the image forming apparatus 10A and the cloud server 20.

As shown in FIG. 6, in a case where only a process of Periodic synchronization 1 is executed between the image forming apparatus 10A and the cloud server 20, first, the control unit 33 of the image forming apparatus 10A transmits a request notification of Periodic synchronization 1 to the cloud server 20 (Step SM11), and executes the process of Periodic synchronization 1 between the image forming apparatus 10A and the cloud server 20.

In a case where the data synchronization is completed, the cloud server 20 transmits a completion notification of Periodic synchronization 1 to the image forming apparatus 10A (Step SS11).

In a case where the control unit 33 of the image forming apparatus 10A receives the completion notification of Periodic synchronization 1 from the cloud server 20, the control unit 33 transmits the completion notification of Periodic synchronization 1 to the cloud server 20 as a response to the completion notification (Step SM13).

Here, it is assumed that a process of Immediate synchronization 1 is generated during the execution of the process of Periodic synchronization 1 (Step SM12), and setting information included in the synchronization item of the process of Immediate synchronization 1 is updated on the image forming apparatus 10A side.

Further, it is assumed that an emergency flag indicating that the process of Immediate synchronization 1 has synchronization items having importance and urgency is set for the process of Immediate synchronization 1.

In a case where the process of Immediate synchronization 1 is generated after the control unit 33 of the image forming apparatus 10A receives the completion notification of Periodic synchronization 1 from the cloud server 20, and before the control unit 33 of the image forming apparatus 10A transmits the completion notification of Periodic synchronization 1 to the cloud server 20, that is, in a case where an occurrence timing of Step SM12 is located between an occurrence timing of Step SS11 and an occurrence timing of Step SM13, the control unit 33 of the image forming apparatus 10A changes the synchronization timing of this synchronization item in accordance with the synchronization item of the process of Immediate synchronization 1.

For example, as described above, in a case where the emergency flag is set for the process of Immediate synchronization 1, in Step SM13, the control unit 33 transmits the completion notification of Periodic synchronization 1 to the cloud server 20, and immediately then continuously requests the cloud server 20 to execute the process of Immediate synchronization 1.

At this time, the control unit 33 transmits an addition request notification of Periodic synchronization 1 to the cloud server 20 as a request for adding the synchronization content in the process of Immediate synchronization 1 to Periodic synchronization 1 that is currently executed (Step SM14). Then, the control unit 33 executes an addition process of Periodic synchronization 1 between the image forming apparatus 10A and the cloud server 20.

In a case where the data synchronization is completed in the addition process, the cloud server 20 transmits an addition completion notification of Periodic synchronization 1 to the image forming apparatus 10A (Step SS12).

In a case where the control unit 33 of the image forming apparatus 10A receives the addition completion notification of Periodic synchronization 1 from the cloud server 20, the control unit 33 transmits the addition completion notification of Periodic synchronization 1 to the cloud server 20 as a response to the completion notification (Step SM15).

In a case where the synchronization item in the process of Immediate synchronization 1 is a synchronization item without importance and urgency, the process of Immediate synchronization 1 may be executed with time after the completion of the process of Periodic synchronization 1. Alternatively, this synchronization item may be included in the next periodic synchronization process.

In addition, in a case where the synchronization process that has been generated earlier is the periodic synchronization process, the synchronization process that has been generated later is the immediate synchronization process, and setting information included in the synchronization item of the immediate synchronization process is not updated on the image forming apparatus 10A side, the control unit 33 may complete the periodic synchronization process and then continuously execute the immediate synchronization process.

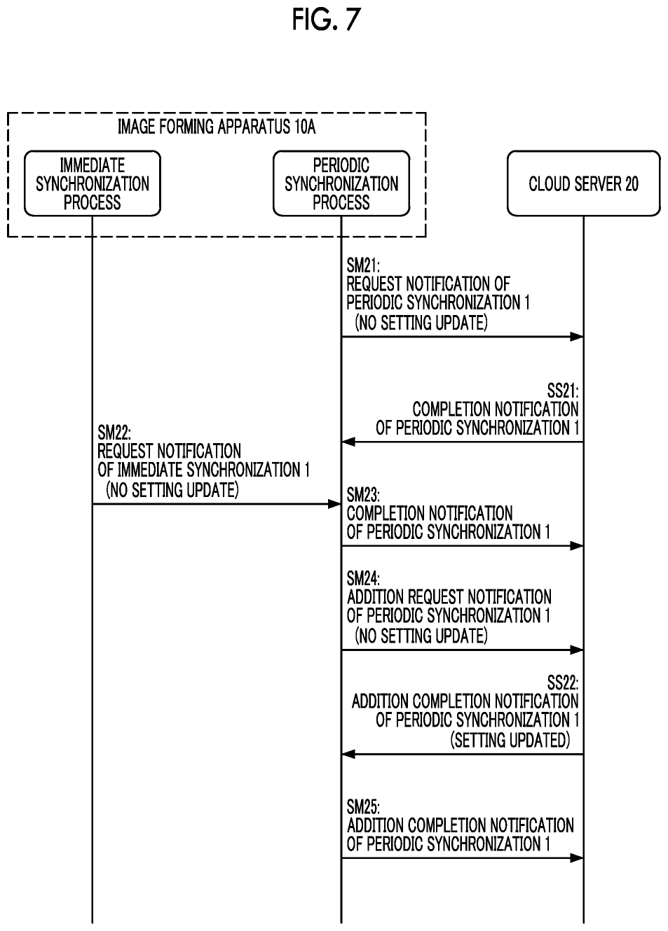

The processing here will be described in detail with reference to FIG. 7. FIG. 7 is a sequence diagram showing a processing flow in a case where the periodic synchronization process and the immediate synchronization process overlap each other between the image forming apparatus 10A and the cloud server 20.

As shown in FIG. 7, in a case where only a process of Periodic synchronization 1 is executed between the image forming apparatus 10A and the cloud server 20, first, the control unit 33 of the image forming apparatus 10A transmits a request notification of Periodic synchronization 1 to the cloud server 20 (Step SM21), and executes the process of Periodic synchronization 1 between the image forming apparatus 10A and the cloud server 20.

In a case where the data synchronization is completed, the cloud server 20 transmits a completion notification of Periodic synchronization 1 to the image forming apparatus 10A (Step SS21).

In a case where the control unit 33 of the image forming apparatus 10A receives the completion notification of Periodic synchronization 1 from the cloud server 20, the control unit 33 transmits the completion notification of Periodic synchronization 1 to the cloud server 20 as a response to the completion notification (Step SM23).

Here, it is assumed that a process of Immediate synchronization 1 is generated during the execution of the process of Periodic synchronization 1 (Step SM22), and setting information included in the synchronization item of the process of Immediate synchronization 1 is not updated on the image forming apparatus 10A side.

In a case where the process of Immediate synchronization 1 is generated after the control unit 33 of the image forming apparatus 10A receives the completion notification of Periodic synchronization 1 from the cloud server 20 and before the control unit 33 of the image forming apparatus 10A transmits the completion notification of Periodic synchronization 1 to the cloud server 20, that is, in a case where an occurrence timing of Step SM22 is located between an occurrence timing of Step SS21 and an occurrence timing of Step SM23, in Step SM23, the control unit 33 of the image forming apparatus 10A transmits the completion notification of Periodic synchronization 1 to the cloud server 20, and immediately then continuously requests the cloud server 20 to execute the process of Immediate synchronization 1.

At this time, the control unit 33 transmits an addition request notification of Periodic synchronization 1 to the cloud server 20 as a request for adding the synchronization content in the process of Immediate synchronization 1 to Periodic synchronization 1 that is currently executed (Step SM24). Then, the control unit 33 executes an addition process of Periodic synchronization 1 between the image forming apparatus 10A and the cloud server 20.

In a case where the data synchronization is completed in the addition process, the cloud server 20 transmits an addition completion notification of Periodic synchronization 1 to the image forming apparatus 10A (Step SS22).

In a case where the control unit 33 of the image forming apparatus 10A receives the addition completion notification of Periodic synchronization 1 from the cloud server 20, the control unit 33 transmits the addition completion notification of Periodic synchronization 1 to the cloud server 20 as a response to the completion notification (Step SM25).

In a case where an instruction of the immediate synchronization process is issued from the user even though the setting information included in the synchronization item of the process of Immediate synchronization 1 is not updated on the image forming apparatus 10A side, it is conceivable that there is an intention to reflect the updated data on the cloud server 20 side to the image forming apparatus 10A side.

Therefore, according to the above aspects, even in a case where a timing at which the data is updated on the cloud server 20 side is located after the completion notification of Periodic synchronization 1 is received from the cloud server 20, and before the completion notification of Periodic synchronization 1 is transmitted to the cloud server 20, that is, even in a case where the timing at which the data is updated on the cloud server 20 side is located between Step SS21 and Step SM23, the data updated on the cloud server 20 side is reliably reflected to the image forming apparatus 10A side.

### Modification Examples

Although the information processing system according to the exemplary embodiment of the present disclosure has been described above, the present disclosure is not limited to the above-described exemplary embodiment and can also be appropriately changed.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, the term “system” in the present exemplary embodiment includes both a system configured by a plurality of devices and a system configured by a single device.

### Supplementary Notes

Hereinafter, supplementary notes of the aspects of the present disclosure will be described.

(((1))

An information processing system comprising:
a processor configured to:
   in a case where a periodic synchronization process of periodically synchronizing data stored in an external device with data in the information processing system overlaps an immediate synchronization process of immediately synchronizing the data stored in the external device with the data in the information processing system in accordance with an instruction from a user, preferentially execute the synchronization process that has been generated earlier.
      (((2)))

The information processing system according to (((1))), wherein the processor is configured to:
execute the synchronization process that has been generated later, after completion of the synchronization process that has been generated earlier.
   (((3)))

The information processing system according to (((2))), wherein the processor is configured to:
in a case where the synchronization process that has been generated earlier is the immediate synchronization process and the synchronization process that has been generated later is a whole-periodic synchronization process in which all types of setting information of the information processing system are synchronized with each other, complete the immediate synchronization process that has been generated earlier, and then continuously execute the whole-periodic synchronization process.
   (((4)))

The information processing system according to (((1))), wherein the processor is configured to:
in a case where the immediate synchronization process is generated during execution of the periodic synchronization process and a synchronization item of the periodic synchronization process is different from a synchronization item of the immediate synchronization process, stop the periodic synchronization process and execute the immediate synchronization process.
   (((5)))

The information processing system according to (((1))), wherein the processor is configured to:
in a case where the synchronization process that has been generated earlier is the periodic synchronization process, the synchronization process that has been generated later is the immediate synchronization process, and there is a synchronization item provided only in the immediate synchronization process, cause the periodic synchronization process to include the synchronization item provided only in the immediate synchronization process and execute the periodic synchronization process.
   (((6)))

The information processing system according to (((1))), wherein the processor is configured to:
in a case where the synchronization process that has been generated earlier is the periodic synchronization process, the synchronization process that has been generated later is the immediate synchronization process, setting information included in a synchronization item of the immediate synchronization process is updated on the information processing system side, and the immediate synchronization process is generated before a completion notification of the periodic synchronization process is received from the external device, request the external device to execute the immediate synchronization process.
   (((7))

The information processing system according to (((6))), wherein the processor is configured to:
in a case where the synchronization process that has been generated earlier is the periodic synchronization process, the synchronization process that has been generated later is the immediate synchronization process, setting information included in a synchronization item of the immediate synchronization process is updated on the information processing system side, and the immediate synchronization process is generated after a completion notification of the periodic synchronization process is received from the external device, change a synchronization timing of the synchronization item in accordance with the synchronization item of the immediate synchronization process.
   (((8)))

The information processing system according to (((1))), wherein the processor is configured to:
in a case where the synchronization process that has been generated earlier is the periodic synchronization process, the synchronization process that has been generated later is the immediate synchronization process, and setting information included in a synchronization item of the immediate synchronization process is not updated on the information processing system side, complete the periodic synchronization process and then continuously execute the immediate synchronization process.
   (((9)))

A program for causing a computer to execute a process comprising:
preferentially executing, in a case where a periodic synchronization process of periodically synchronizing data stored in an external device with data in an information processing system overlaps an immediate synchronization process of immediately synchronizing the data stored in the external device with the data in the information processing system in accordance with an instruction from a user, the synchronization process that has been generated earlier.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
in a case where a periodic synchronization process of periodically synchronizing data stored in an external device with data in the information processing system overlaps an immediate synchronization process of immediately synchronizing the data stored in the external device with the data in the information processing system in accordance with an instruction from a user, preferentially execute the synchronization process that has been generated earlier.

2. The information processing system according to claim 1, wherein the processor is configured to:
execute the synchronization process that has been generated later, after completion of the synchronization process that has been generated earlier.

3. The information processing system according to claim 2, wherein the processor is configured to:
in a case where the synchronization process that has been generated earlier is the immediate synchronization process and the synchronization process that has been generated later is a whole-periodic synchronization process in which all types of setting information of the information processing system are synchronized with each other, complete the immediate synchronization process that has been generated earlier, and then continuously execute the whole-periodic synchronization process.

4. The information processing system according to claim 1, wherein the processor is configured to:
in a case where the immediate synchronization process is generated during execution of the periodic synchronization process and a synchronization item of the periodic synchronization process is different from a synchronization item of the immediate synchronization process, stop the periodic synchronization process and execute the immediate synchronization process.

5. The information processing system according to claim 1, wherein the processor is configured to:
in a case where the synchronization process that has been generated earlier is the periodic synchronization process, the synchronization process that has been generated later is the immediate synchronization process, and there is a synchronization item provided only in the immediate synchronization process, cause the periodic synchronization process to include the synchronization item provided only in the immediate synchronization process and execute the periodic synchronization process.

6. The information processing system according to claim 1, wherein the processor is configured to:
in a case where the synchronization process that has been generated earlier is the periodic synchronization process, the synchronization process that has been generated later is the immediate synchronization process, setting information included in a synchronization item of the immediate synchronization process is updated on the information processing system side, and the immediate synchronization process is generated before a completion notification of the periodic synchronization process is received from the external device, request the external device to execute the immediate synchronization process.

7. The information processing system according to claim 6, wherein the processor is configured to:
in a case where the synchronization process that has been generated earlier is the periodic synchronization process, the synchronization process that has been generated later is the immediate synchronization process, setting information included in a synchronization item of the immediate synchronization process is updated on the information processing system side, and the immediate synchronization process is generated after a completion notification of the periodic synchronization process is received from the external device, change a synchronization timing of the synchronization item in accordance with the synchronization item of the immediate synchronization process.

8. The information processing system according to claim 1, wherein the processor is configured to:
in a case where the synchronization process that has been generated earlier is the periodic synchronization process, the synchronization process that has been generated later is the immediate synchronization process, and setting information included in a synchronization item of the immediate synchronization process is not updated on the information processing system side, complete the periodic synchronization process and then continuously execute the immediate synchronization process.

9. A non-transitory computer readable medium storing a program for causing a computer to execute a process comprising:
preferentially executing, in a case where a periodic synchronization process of periodically synchronizing data stored in an external device with data in an information processing system overlaps an immediate synchronization process of immediately synchronizing the data stored in the external device with the data in the information processing system in accordance with an instruction from a user, the synchronization process that has been generated earlier.

10. An information processing method comprising:
preferentially executing, in a case where a periodic synchronization process of periodically synchronizing data stored in an external device with data in an information processing system overlaps an immediate synchronization process of immediately synchronizing the data stored in the external device with the data in the information processing system in accordance with an instruction from a user, the synchronization process that has been generated earlier.
